(19) United States
(12) Patent Application Publication
(10) Pub. No.: US 2017/0203479 A1
(43) Pub. Date: Jul. 20, 2017

(54) IN MOLD DECORATION OF A FILM LAMINATED SUBSTRATE

(71) Applicant: SABIC GLOBAL TECHNOLOGIES B.V., Bergen op Zoom (NL)

(72) Inventors: Michael M. Laurin, Pittsfield, MA (US); Scott M. Davis, Washington, MA (US); Christopher T. Wall, Dalton, MA (US); Charlie W. Wood, Peru, MA (US); Rakshit Amba, East Greenbush, NY (US); Timothy M. Allessio, Dalton, MA (US)

(21) Appl. No.: 15/324,584

(22) PCT Filed: Jul. 9, 2015
(86) PCT No.: PCT/US2015/039745

§ 371 Date: Jan. 6, 2017

Related U.S. Application Data
(60) Provisional application No. 62/022,466, filed on Jul. 9, 2014.
(60) Provisional application No. 62/022,333, filed on Jul. 9, 2014.

(51) Int. Cl. B29C 45/14; B29C 65/48

(52) U.S. Cl. CPC B29C 45/14311; B29C 65/48; B29C 45/14336; B29C 45/14688; B29K 2669/00

(57) ABSTRACT

An article of manufacturing can comprise a mold insert comprising: a cap substrate having a first surface and a second surface; an adhesive coupled to a portion of the second surface of the cap substrate; a base substrate having a first surface and a second surface, wherein the first surface of the base substrate is coupled to the adhesive, wherein the adhesive is disposed between the second surface of the cap substrate and the first surface of the base substrate; and a polymeric resin attachment, wherein the polymeric resin attachment is coupled to a portion of the second surface of the base substrate, wherein the polymeric resin extends along an edge of the base substrate, and along an edge of the cap substrate.

### BACKGROUND

An electronic device can have a control panel where a user can interact with the device. The control panel can have layers that can include a display source, a touch sensing device, and/or a cover window disposed over touch sensing device. The control panel can display information to a user and interpret the user's physical contact with a surface of the panel. A user can interact with the device by touching the surface of the cover window. An image can be projected through the panel from the display source. The cover window can include glass which can provide a transparent protective layer and can cover the touch sensing device. Glass can be transparent and can be resilient to abrasion and thus can be suitable as a cover window. However, glass can be brittle and susceptible to cracking and failure (e.g., when impacted along an edge). Additionally, it can be difficult for polymer resin to adhere directly to a glass substrate. Additives, surface treatments, and/or adhesives can be used in an effort to improve the adhesion, yet an interface between the glass and the polymer resin can remain a weak point where separation can occur.

Thus there is a need in the art for articles which can have a polymer resin material bonded to a substrate and methods that can improve the bonding, reduce or eliminate warping, reduce manufacturing costs, provide greater design freedom, or a combination including at least one of the foregoing.

### BRIEF DESCRIPTION

An article of manufacturing can comprise: a mold insert comprising: a cap substrate having a first surface and a second surface; an adhesive coupled to a portion of the second surface of the cap substrate; a base substrate having a first surface and a second surface, wherein the first surface of the base substrate is coupled to the adhesive, wherein the adhesive is disposed between the second surface of the cap substrate and the first surface of the base substrate; and a polymeric resin attachment, wherein the polymeric resin attachment is coupled to a portion of the second surface of the base substrate, wherein the polymeric resin extends along an edge of the base substrate, and along an edge of the cap substrate.

A method for forming an article of manufacturing can comprise: applying an adhesive to a surface of a first substrate; coupling a second substrate to the adhesive to form a mold insert, wherein the adhesive is sandwiched between the first substrate and the second substrate; molding a polymeric resin attachment to the mold insert in an injection molding process to form an article; wherein the polymeric resin attachment is coupled to a portion of one of the first substrate and second substrate, and wherein the polymeric resin attachment extends along a portion of an edge of the mold insert.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of a portion of a cross-section of an article of manufacture including a cap substrate, base substrate, adhesive and polymeric resin attachment.

FIG. 2 is an illustration of a portion of a cross-section of an article of manufacture including a polymeric resin attachment formed into more than one section.

FIG. 3 is an illustration of a portion of a cross-section of an article of manufacture including a cap substrate, base substrate, adhesive, functional layer and polymeric resin attachment.

FIG. 4 is an illustration of a portion of a cross-section of an article of manufacture including a cap substrate, base substrate, adhesive, functional layer and a polymeric resin attachment formed into more than one section.

FIG. 5 is an illustration of measurement points for determining warpage of polymeric resin attachments including a filler material.

FIG. 6A is a top view of a mold with features to assist in aligning a mold insert within the mold.

FIG. 6B is a cross-sectional view of a mold with features to assist in aligning a mold insert within the mold.

FIG. 7 is a graphical representation of the results from a flat face drop test.

FIG. 8 is graphical representation of the results from a 30° angle face drop test.

### DETAILED DESCRIPTION

A problem to be solved can include selecting a polymer resin attachment composition which can reduce or eliminate warping when applying it to a substrate to form an article in a way that can allow for high visible light transmittance through the article, can be inexpensive, and where the polymer resin can be adhered in a way to the substrate such that it can reduce susceptibility to separation or breakage of the substrate along the substrate/polymer interface. The present subject matter can help provide a solution to this problem, such as by providing a base substrate that is capable of being laminated to a cap substrate where the base substrate can also bond to a polymer resin attachment in such a way as to provide strong adhesion between the substrate and the polymer resin and prevent warping of an article of manufacture.

Disclosed herein is an article of manufacture as well as a method of forming the same. The article can include a cap substrate, a base substrate, an adhesive, and a polymeric resin attachment. The article can include an optional functional layer adhered to a surface of the cap substrate. The article can include an optional functional layer adhered to a surface of the base substrate. The optional functional layer can include an ultraviolet light protection layer, a touch sensing layer, abrasion resistant layer, infrared absorbing layer, infrared reflecting layer, hydrophobic layer, hydrophilic layer, anti-fingerprint layer, anti-smudge layer, antimicrobial layer, conductive layer, electromagnetic radiation shielding layer (e.g., an electromagnetic interference shielding layer), anti-frost layer, anti-fog layer, image forming layer (e.g., an ink layer), or a combination including at least one of the foregoing. The functional layer can be disposed in any form, e.g., a film, coating, coextruded layer, deposited layer, molded layer, or the like. The functional material of a functional layer can be an additive incorporated into the adhesive, the cap substrate, or the base substrate, or a combination including at least one of the foregoing, such as giving a substrate or adhesive the functional properties without forming a separate layer.

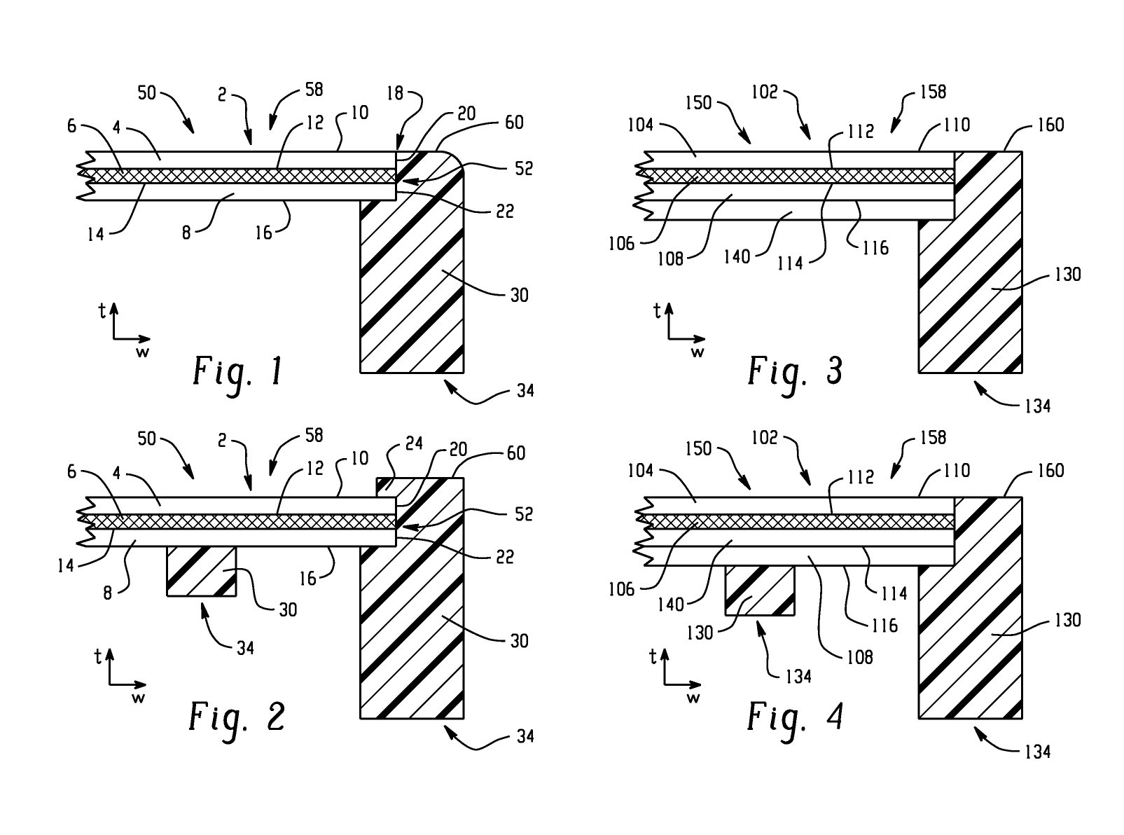

FIGS. 1-2 illustrate an article of manufacture 2 including a mold insert 50 having an edge 52, and a polymeric resin attachment 30. The mold insert 50 can include a cap substrate 4, an adhesive 6, and a base substrate 8. The cap substrate 4 can be any shape. The cap substrate 4 can be flat. The cap substrate 4 can be 0.05 millimeters (mm) to 5.0 mm thick, for example, 0.05 mm to 1.5 mm, or, 0.3 mm to 1.0 mm, or, 0.4 mm to 1.0 mm, or, 0.55 mm to 0.7 mm as measured in along the shortest dimension of the cap substrate 4 (along the t-axis in the figures). The cap substrate 4 can have a first surface 10, a second surface 12, and an edge 20. A surface (e.g., the first surface 10) of the cap substrate 4 can form an outer surface of the article 2. A surface (e.g., the second surface 12) of the cap substrate 4 can be coupled (e.g. adhered) to the base substrate 8 by an adhesive 6. The cap substrate 4 can exhibit curvature in a dimension. The cap substrate 4 can be formed into a three dimensional shape.

An evaluation of a glass cap substrate 4 laminated to a 0.254 mm thick polycarbonate base substrate 8 with a thermal plastic urethane (TPU) adhesive 6 was performed to determine suitability of the mold insert 50 for insert molding as a function of the thicknesses of the cap substrate 4 and the adhesive 6. The results of the evaluation are provided in Table 1.

TABLE 1
Mold Insert Suitability as a Function of Cap
Substrate and Adhesive Thickness

| Cap Substrate | Adhesive Thickness | |
|---|---|---|
| Thickness (mm) | (mm) | Observations |
| 0.0508 | 0.102 | cracked |
| 0.0508 | 0.381 | cracked |
| 0.0508 | 1.27 | cracked |
| 0.203 | 0.102 | no cracks |
| 0.203 | 0.381 | no cracks |
| 0.203 | 1.27 | cracked |
| 0.711 | 0.102 | no cracks |
| 0.711 | 0.381 | no cracks |
| 0.711 | 1.27 | cracked |

The cap substrate 4 can be made of any material, including glass, thermoplastics, wood, metal, ceramic, stone, reinforcing fiber, or a combination comprising at least one of the foregoing. Reinforcing fiber as used herein, can refer to a carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), or a combination including at least one of the foregoing.

An evaluation of various cap substrates 4 laminated to a 0.008 mm thick polycarbonate base substrate 8 using a 1 mm thick silicone based pressure sensitive adhesive (PSA) adhesive 6 was performed to determine suitability of the mold insert 50 for insert molding as a function of the cap substrate 4 bonded to the base substrate 8. The results of the evaluation are provided in Table 2. The resin used for the polycarbonate base substrate 8 was a 40% glass filled polycarbonate resin.

TABLE 2
Cap Substrate Suitability for Insert Molding with Polycarbonate
After Lamination to Polycarbonate

| | Cap | |
|---|---|---|
| | Thickness | Observations |
| Cap Substrate Material | (mm) | after molding |
| Wood Veneer | 0.6 | Survived molding |
| Chemically Strengthened Glass | 0.55 | Survived molding |
| Non-Strengthened Glass | 0.05 | Some yield loss due |
| | | to glass cracking |
| | | during molding |
| Non-Strengthened Glass | 0.1 | Survived molding |
| Non-Strengthened Glass | 0.2 | Survived molding |
| Carbon fiber laminate | 1 | Survived molding |
| Glass fiber laminate | 1 | Survived molding |
| Stainless Steel | 0.4 | Survived molding |
| Copper | 0.4 | Survived molding |
| Aluminum | 0.4 | Survived molding |
| Optically Transparent Synthetic | 0.7 | Survived molding |
| Crystal | | |

As can be seen from Table 2, nearly all the materials tested for the cap substrate survived molding. A wood veneer cap substrate can have a thickness as measured along the shortest dimension of 0.1 to 1.0 mm, for example, 0.25 to 0.75 mm, for example, 0.3 to 0.6 mm, for example, 0.3 mm, for example, 0.5 mm, for example, 0.6 mm, for example, 0.75 mm. A chemically strengthened glass cap substrate can have a thickness of 0.3 mm to 1 mm, for example, 0.4 mm to 0.7 mm as measured along the shortest dimension. A carbon fiber laminate or glass fiber laminate cap substrate can have a thickness as measured along the shortest dimension of 0.5 to 2 mm, for example, 0.75 to 1.75 mm, for example, 1.0 to 1.5 mm, for example, 0.75 mm, for example, 1.0 mm, for example, 1.5 mm. A stainless steel, copper, or aluminum cap substrate can have a thickness of 0.1 to 1.0 mm, for example, 0.25 to 0.75 mm, for example, 0.3 to 0.6 mm, for example, 0.25 mm, for example, 0.4 mm, for example, 0.6 mm. An optically transparent synthetic crystal cap substrate can have a thickness as measured along the shortest dimension of 0.25 to 1.0 mm, for example, 0.5 to 0.75 mm, for example, 0.6 to 0.7 mm, for example, 0.3 mm, for example, 0.5 mm, for example, 0.7 mm. A non-strengthened glass cap substrate can have a thickness as measured along the shortest dimension of 0.05 to 1.0 mm, for example, 0.1 to 0.5 mm, for example, 0.1 to 0.2 mm, for example, 0.05 mm, for example, 0.075 mm, for example, 0.1 mm, for example, 0.2 mm. Desirable bonding can be achieved when injection molded resins 30 containing some portion of the resin used to make the base substrate 8 of the insert 50 are injected onto the insert. For example, the base substrate 8 of the insert 50 can be polypropylene or polyester and that the polymeric resin attachment 30 can include a resin containing a portion of polypropylene or polyester, respectively.

The cap substrate 4 can include chemically strengthened glass (e.g., CORNING™ GORILLA™ Glass commercially available from Corning Inc., XENSATION™ glass commercially available from Schott AG, DRAGONTRAIL™ glass commercially available from Asahi Glass Company, LTD, and CX-01 glass commercially available from Nippon Electric Glass Company, LTD, this list is not inclusive of all chemically hardened glass products). The cap substrate 4 can include non-strengthened glass, such as non-hardened glass including low sodium glass (e.g., CORNING™ WILLOW™ Glass commercially available from Corning Inc. and OA-10G Glass-on-Roll glass commercially available from Nippon Electric Glass Company, LTD, this list is not inclusive of all non-hardened glass products). The cap substrate can include sapphire glass commercially available from GT Advanced Technologies Inc. In some embodiments, the cap substrate 4 can include GORILLA™ glass and the cap substrate 4 can have a thickness as measured along the shortest dimension of 0.3 mm to 1 mm, or 0.4 mm to 0.7 mm. In some embodiments, the cap substrate 4 can include WILLOW™ glass and the cap substrate 4 can have a thickness as measured along the shortest dimension of 0.05 mm to 0.3 mm, or, 0.1 mm to 0.2 mm. In some embodiments, the cap substrate 4 can include Sapphire glass and the cap substrate 4 can have a thickness as measured along the shortest dimension of 0.06 mm to 2 mm, or, 0.6 mm to 0.7 mm.

The adhesive 6 can be disposed adjacent to a surface of the cap substrate 4. For example, the adhesive 6 can be disposed adjacent to the second surface 12 of the cap substrate 4. The adhesive 6 can be applied such that the thickness can be less than 2.0 mm, for example, 0.05 mm to 1.0 mm, or, 0.2 mm to 0.8 mm. The adhesive 6 can be sandwiched between a surface of the cap substrate 4 and a surface of the base substrate 8. The adhesive 6 can be in mechanical communication with both a surface of the cap substrate 4 and a surface of the base substrate 8. The adhesive 6 can be applied to the cap substrate 4, to the base substrate 8, or to both the cap substrate 4 and the base substrate 8. The adhesive 6 can be applied using any desirable process including roll lamination, roller coating, screen printing, spreading, spray coating, spin coating, dipping, and the like.

It has been found that when the mold insert 50 is formed with an adhesive 6 that is applied at a temperature above room temperature the mold insert can exhibit an undesired curvature. The Applicant is not required to provide a description of the theory of operation of the invention and the appended claims should not be limited by the Applicant's statements regarding such theory, but it is thought that if an adhesive 6 is applied at an elevated temperature, then when it cools the adhesive 6 and base substrate 8 can contract and can bend the mold insert 50 such that the mold insert 50 can be given an un-planned curvature as a result. This can be the case when the flexural stiffness of the cap substrate 4 is not high enough to prevent the shrinkage of the base substrate 8 or the adhesive 6 from causing the insert to form an undesired curvature. One strategy which can prevent an undesired curvature can be to apply the adhesive 6 at or near room temperature, such as a temperature of 15° C. to 45° C. Another strategy which can prevent an undesired curvature can be to increase the thickness and/or stiffness of the cap substrate 4 such that it can overcome the shrinkage force of the base substrate 8 and adhesive 6.

In an example, 0.7 mm thick chemically strengthened glass (e.g., GORILLA™ glass) was bonded to a 0.25 mm polycarbonate (PC) film (e.g., LEXAN™ film) with 0.1 mm to 1.3 mm of a thermal plastic urethane (TPU) adhesive 6. In these examples, even though the temperatures to cure the TPU were well above room temperature, the stiff glass prevented the undesired curvature as shown in Table 3. In Table 3, the position of the sample points is as follows: point A is at L=0, point B is at L=L/2, and point C is at L=L for a sample of length L (measured in the longest dimension of the sample), and point D is at W=0, point E is at W=W/2, and point F is at W=W for a sample of width W (measured in a dimension perpendicular to a plane formed by the length and thickness dimensions of the sample, e.g., the w-axis dimension in the figures). The Samples were tested for 100 minutes at 100° C. and 220 minutes at 80° C., pressure was 69 Newtons per square centimeter (N/cm²) and vacuum was held for 220 minutes at 0 mbar (0 Pascals) pressure.

TABLE 3
Evaluation of Warp as a function of
Base Substrate and Adhesive Thickness

| Sample 1 | Thickness (mm) | | | |
|---|---|---|---|---|
| | TPU | | 1.27 | |
| | PC | | 6.35 | |
| | Height from Table to top of sample at points A-F (mm) | | | |
| | A | 7.52 | D | 7.47 |
| | B | 9.53 | E | 8 |
| | C | 7.47 | F | 7.34 |
| | Standard Deviation | | 0.763 | |
| Sample 2 | Thickness (mm) | | | |
| | TPU | | 0.635 | |
| | PC | | 3.175 | |
| | Height from Table to top of sample at points A-F (mm) | | | |
| | A | 5 | D | 4.88 |
| | B | 15.42 | E | 7.85 |
| | C | 4.88 | F | 5 |
| | Standard Deviation | | 3.839 | |
| Sample 3 | Thickness (mm) | | | |
| | TPU | | 0.381 | |
| | PC | | 3.175 | |
| | Height from Table to top of sample at points A-F (mm) | | | |
| | A | 4.72 | D | 4.9 |
| | B | 16.69 | E | 5.26 |
| | C | 4.9 | F | 4.98 |
| | Standard Deviation | | 4.377 | |
| Sample 4 | Thickness (mm) | | | |
| | TPU | | 0.102 | |
| | PC | | 2.03 | |
| | Height from Table to top of sample at points A-F (mm) | | | |
| | A | 3.07 | D | 3.3 |
| | B | 20.32 | E | 5.26 |
| | C | 3.3 | F | 3.1 |
| | Standard Deviation | | 6.275 | |
| Sample 5 | Thickness (mm) | | | |
| | TPU | | 0.102 | |
| | PC | | 0.25 | |
| | Height from Table to top of sample at points A-F (mm) | | | |
| | A | 0 | D | 0 |
| | B | 0.15 | E | 0 |
| | C | 0 | F | 0 |

| | |
|---|---|
| Standard Deviation | 0.0559 |

In the above experiment it was found that the thickness of the polycarbonate can affect the amount of warp observed in an unbalanced laminated sample, where lamination was conducted at temperatures and pressures high enough to cause the thermal plastic urethane adhesive to melt and flow. Similar results were observed when using ethyl vinyl acetate (EVA) interlayer adhesives. When the polycarbonate layer of the laminate was sufficiently thin, as in Sample 5, the shrinkage of the polycarbonate did not create enough stress to overcome the stiffness of the glass. The result was a much flatter finished part, e.g., having a smaller standard deviation in the measurement of the height from a fixed plane. In Samples 1-4 the shrinkage of the polycarbonate created enough stress in the sample to cause significant warp in the part.

The adhesive 6 can be any adhesive that can withstand exposure to a molding process (e.g., exposure to a mold tool temperature of up to 200° C. and/or molding material temperature of up to 360° C.) and which will not chemically attack the base substrate 8 or cap substrate 4. Chemical attack can be determined by applying an adhesive 6 to a substrate to form a sample and comparing the physical properties of the sample before and after it is placed in a 1700-2000 pound per square inch (psi, gauge) (11.7 to 13.8 MegaPascal (MPa)) strain fixture and held at a temperature of 70° C. for 1 week. If the mechanical properties (e.g., tensile strength, flexural modulus, and the like) are greater than or equal to 95% of their original value (before the 1 week test) and there are no visual signs of attack (e.g., stress cracks) then the adhesive can be considered to not attack the substrate material. In an embodiment, the adhesive is a hindered amine light stabilizer free ethyl vinyl acetate (HALS free EVA). In an embodiment the adhesive 6 is a thermal plastic urethane. In an embodiment the adhesive 6 is an ultra violet light cured modified acrylate optical quality adhesive. In an embodiment the adhesive 6 is a silicone based pressure sensitive adhesive. In an embodiment the adhesive 6 is an acrylate based pressure sensitive adhesive. An evaluation of some adhesives is provided in Table 4. Chemical compatibility was measured for a period of 7 days exposure at 70° C. on a 2,000 psi (13.8 MegaPascal (MPa)) stress jig; the peel test was conducted by measuring a 90° peel force of 1 inch (25.4 mm) wide LEXAN™ film bonded to soda lime glass with one of the adhesives listed in Table 4 and reported in pounds per linear inch (PLI) and Newtons per meters (N/m); average lap shear was measured by testing 1 inch (25.4. mm) samples of soda lime glass bonded over 1 inch (25.4 mm) to a LEXAN™ sheet and reported in pounds per square inch (psi) and kilopascals (kPa)). “NT in Table 4 refers to “Not Tested.”

TABLE 4
Adhesive Testing Results

| | | | | | Avg. | |
|---|---|---|---|---|---|---|
| | | | | Avg. 90° | Lap | |
| | | | | Peel Test | Sheer | |
| | | | Chemical | (PLI; | (psi; | |
| Manufacturer | Color | Product | Compatibility | N/m) | kPa) | Remarks |
| 3M | Clear | Contact Adhesive for | Fail | | | |
| | | Plastics #4475, 32 Ounce | | | | |
| | | Can | | | | |
| 3M | Clear | Adhesive Cartridge | Pass | NT | NT | Yellowed |
| | | DP100 Epoxy, 1.69 | | | | During |
| | | Ounces | | | | Heating |
| 3M | Clear | 8264N | Pass | 4.6; 806 | 83.4; | |
| | | | | | 575.0 | |
| 3M | clear | 8171, PSA | Pass | 6.8; | NT | |
| | | | | 1,191 | | |
| 3M | Clear | Adhesive Cartridge | Fail | NT | NT | |
| | | DP100 Plus High | | | | |
| | | Strength Epoxy, 1.69 | | | | |
| | | Ounces | | | | |
| 3M | Clear | Glue-on-A-Roll Hand- | Pass | 5.0; 876 | NT | Yellowed |
| | | Dispensed, VHB, | | | | During |
| | | #F9473PC, 1″ Wd, 60 | | | | Heating |
| | | Yards Long | | | | |
| 3M | Clear | Adhesive Cartridge | Pass | 0.2; 35.0 | NT | Yellowed |
| | | DP100 Epoxy, 6.76 | | | | During |
| | | Ounces | | | | Heating |
| 3M | Clear | Adhesive Cartridge | Pass | NT | NT | Yellowed |
| | | DP105 Flexible Epoxy, | | | | During |
| | | 1.69 Ounces | | | | Heating |
| 3M | Clear | Super Silicone Sealant | Pass | 6.8; | NT | Not |
| | | #8661, 3 ounce Tube | | 1,191 | | Optically |
| | | | | | | Clear |
| 3M | Clear | Super Silicone Sealant | Pass | NT | NT | Not |
| | | #8663, 10.3 ounce | | | | Optically |
| | | Cartridge | | | | Clear |
| Adhesive | Clear | Arclear 92524 | Pass | 3.5; 613 | NT | |
| Research | | | | | | |
| Adhesive | Clear | IS-8026-15 | Pass | 2.6; 455 | 65.1; | |
| Research | | | | | 448.9 | |
| Adhesive | Clear | EL-92892 | Pass | 3.6; 630 | NT | |
| Research | | | | | | |
| Adhesive | Clear | AR Clear EL-8932EE- | Pass | 7.6; | NT | |
| Research | | 45, PSA | | 1,331 | | |
| Adhesive | Clear | IS7876-36, PSA | Pass | 5.9; | NT | |
| Research | | | | 1,033 | | |
| Cytec | Clear | DM1000 | NT | 3.8; 665 | NT | |
| Cytec | Clear | DM1000 - urethane | Pass | 3.8; 665 | NT | |
| Cytec | Clear | 21814 | Pass | 2.6; 323 | 160.0; | glass |
| | | | | | 1103.2 | broke, |
| | | | | | | peel |
| | | | | | | values |
| | | | | | | are low |
| | | | | | | but over |
| | | | | | | 10 start |
| | | | | | | value |
| Devcon | Clear | Cartridge 14260 High | Fail | NT | NT | |
| Adhesive | | Strength Epoxy, 1.69 | | | | |
| | | Ounces | | | | |
| Devcon | Clear | Cartridge 14251 Impact | Pass | NT | NT | Yellowed |
| Adhesive | | Resistant Epoxy, 1.69 | | | | During |
| | | Ounces | | | | Heating |
| Dow Corning | Clear | HM2515 hot melt, | Pass | 24.6; | NT | |
| | | silicone | | 4,308 | | |
| Dow Corning | Clear | Sylgard 184 two part | Pass | poor | NT | |
| | | silicone with 1200 OS | | bond | | |
| | | primer | | no | | |
| | | | | measurable | | |
| | | | | value | | |
| Dow Corning | Clear | X3-6211 | Pass | poor | NT | |
| | | | | bond | | |
| | | | | no | | |
| | | | | measurable | | |
| | | | | value | | |
| Dow Corning | Clear | Silicone Sealant #733, | Pass | NT | NT | Not |
| | | 10.1 Ounce Cartridge | | | | Optically |
| | | | | | | Clear |
| Dow Corning | Clear | Self-Leveling Sealant | Pass | NT | NT | Not |
| | | #734 3.0-Ounce Tube | | | | Optically |
| | | | | | | Clear |
| Dow Corning | Clear | Silicone Sealant #700 3 | Pass | NT | NT | Not |
| | | Ounce Tube | | | | Optically |
| | | | | | | Clear |
| Dow Corning | Clear | Sealant #737, 10.1 | Pass | NT | NT | Not |
| | | Ounce Cartridge, Clear | | | | Optically |
| | | | | | | Clear |
| Dow Corning | Clear | Silicone Sealant Number | Pass | NT | NT | Not |
| | | 732, 3.0-Ounce Tube, | | | | Optically |
| | | Clear | | | | Clear |
| DYMAX | Clear | 9701-UV Cure | Fail | NT | NT | |
| DYMAX | Clear | 4-20418 | Fail | NT | NT | |
| Engineered | Clear | UV9059 | Pass | 90.1; | >155; | glass |
| Materials | | | | 15,779 | >1068.7 | broke |
| Systems Inc. | | | | | | |
| Engineered | Clear | UV9014 | Pass | 20.3; | 159.0; | two |
| Materials | | | | 3,555 | 1096.3 | samples |
| Systems Inc. | | | | | | fell apart |
| | | | | | | while |
| | | | | | | loading |
| Engineered | slightly | UV9108F | Pass | 11.6; | 175.0; | slightly |
| Materials | yellow | | | 2,031 | 1206.6 | yellow, |
| Systems Inc. | | | | | | inconsistent |
| | | | | | | peels |
| Engineered | Clear | UV9058 | Pass | 104.5; | >132; | glass |
| Materials | | | | 18,300 | >910.1 | broke |
| Systems Inc. | | | | | | |
| Engineered | Clear | UV9054 | Pass | 5.5; 963 | 191.0; | |
| Materials | | | | | 1316.9 | |
| Systems Inc. | | | | | | |
| Engineered | slight | UV9019V | Pass | 16.3; | >359; | glass |
| Materials | amber | | | 2,855 | >2475.2 | broke, |
| Systems Inc. | | | | | | slight |
| | | | | | | amber |
| | | | | | | tint |
| Engineered | slight | UV9017 | Pass | 137.9; | >145; | glass |
| Materials | straw | | | 24,150 | >999.7 | broke, |
| Systems Inc. | | | | | | slight |
| | | | | | | straw |
| | | | | | | color |
| Engineered | Clear | UV9054 | Pass | 3.8; 665 | 191.0; | |
| Materials | | | | | 1316.9 | |
| Systems Inc. | | | | | | |
| Flexcon | Clear | DF132311, PSA | Pass | 11.3; | NT | |
| | | | | 1,979 | | |
| Flexcon | Clear | V58, PSA | Pass | NT | NT | |
| Henkel | Clear | B7707A | Fail | NT | NT | |
| Henkel | Clear | 395HC | Fail | NT | NT | |
| Henkel Emerson | Clear | 15D | Pass | 0.3; 52.5 | 332.0; | |
| and Cummings | | | | | 2289.1 | |
| Henkel Emerson | Clear | 15C | Pass | 4.0; | 234.5; | |
| and Cummings | | | | 700.5 | 1616.7 | |
| High-Strength | Clear | High-Strength Sealant | Fail | NT | NT | |
| Sealant | | 3.7 Ounce Tube, Clear | | | | |
| High- | Clear | 32 Ounce Bottle of High- | Fail | NT | NT | Yellowed |
| Temperature | | Temperature Glue | | | | During |
| Glue | | | | | | Heating |
| Huntsman | Clear | 399 TPU | Pass | 35.0; | NT | |
| | | | | 6,129 | | |
| J-B Weld | Clear | Adhesive 50112, Quick | Fail | NT | NT | |
| | | Setting, 0.85 Ounce | | | | |
| | | Syringe | | | | |
| Loctite | Optically | Epoxy Adhesive in a | Fail | NT | NT | |
| | Clear | Tube 0151 | | | | |
| Loctite | Clear | High-Purity Adhesive M- | Fail | NT | NT | |
| | | 31CL Easy Flowing | | | | |
| | | Epoxy, 1.7 Ounces | | | | |
| Loctite | Clear | Adhesive Cartridge E- | Fail | NT | NT | |
| | | 30CL Epoxy for Glass, | | | | |
| | | Optical Fibers & | | | | |
| | | Ceramic | | | | |
| Loctite | Clear | Adhesive Cartridge U- | Fail | NT | NT | |
| | | 09FL Flexible Urethane | | | | |
| | | for Polycarbonate, 1.69 | | | | |
| | | Ounces | | | | |
| Loctite | Clear | 0151 Hysol Epoxy | Fail | NT | NT | |
| | | Adhesive, 2.6 lb Kit | | | | |
| Loctite | Clear | Light-Activated | Fail | NT | NT | |
| | | Adhesive #3751, 0.84 | | | | |
| | | Ounces Syringe | | | | |
| Loctite | Clear | Light-Activated | Fail | NT | NT | |
| | | Adhesive for | | | | |
| | | Polycarbonate, #3103, | | | | |
| | | 0.84 Ounce Syringe | | | | |
| Loctite | Clear | Epoxy, 0.84 Ounce | Fail | NT | NT | |
| | | Adhesive in a Syringe | | | | |
| | | 1324007 | | | | |
| Loctite | Clear | 3106 UV cured acrylated | NT | poor | NT | |
| | | urethane | | bond | | |
| | | | | no | | |
| | | | | measurable | | |
| | | | | value | | |
| Loctite | Clear | 3492 UV cured modified | NT | poor | NT | |
| | | acrylate | | bond | | |
| | | | | no | | |
| | | | | measurable | | |
| | | | | value | | |
| Loctite | Clear | High-Purity Adhesive M- | Pass | 3.2; 560 | NT | |
| | | 11FL Easy Flowing | | | | |
| | | Urethane, 1.7 Ounces | | | | |
| Loctite | Clear | 3494 | Pass | 1.7; 298 | NT | PC/Glass |
| | | | | | | bond is |
| | | | | | | poor |
| Loctite | Semi | 3974 | Pass | 50.8; | >169; | glass |
| | transparent | | | 3,643 | >1165.2 | broke, |
| | | | | | | semi |
| | | | | | | transparent |
| Loctite | Clear | 3494 UV cured modified | Pass | 26; 4,553 | 205.5 | brittle |
| | | acrylate | | peak but | 1416.9 | failure of |
| | | | | 0.7; 123 | | bond and |
| | | | | peel | | LEXAN ™ |
| | | | | | | sheet, high |
| | | | | | | peak |
| | | | | | | value on |
| | | | | | | 90 peel |
| | | | | | | but no |
| | | | | | | strength |
| | | | | | | once |
| | | | | | | started |
| Loctite | Clear | E30CL 2 part epoxy | Pass | 112.5; | 411.0; | 5-15% |
| | | (epoxy + amine) | | 19,701 | 2833.8 | strain at |
| | | | | | | break, |
| | | | | | | brittle |
| | | | | | | failure of |
| | | | | | | adhesive, |
| | | | | | | optically |
| | | | | | | clear |
| | | | | | | bond |
| Loctite | Clear | 5056 one pass UV D | Pass | 8.0; | 50.3; | |
| | | bulb | | 1,401 | 346.6 | |
| Loctite | Clear | 5056 two passes UV D | Pass | 9.5; | 77.6; | |
| | | bulb | | 1,664 | 535 | |
| Lord Adhesive | Clear | Cartridge 7550A/C | Fail | NT | NT | |
| | | Urethane for Plastics, | | | | |
| | | 1.69 Ounces | | | | |
| Master Bond | Clear | EP30P | Fail | NT | NT | |
| Master Bond | Clear | UV15-7 | Fail | NT | NT | |
| Momentive/GE | Semi- | Easy Flowing Sealant | Pass | NT | NT | Not |
| Silicone | Clear | RTV118, 2.8 Ounce | | | | Optically |
| | | Tube | | | | Clear |
| Permabond | Clear | UV AG3026/2, UV | Fail | 82.6; | 207.0; | cohesive |
| | | cured modified acrylate | | 14,465 | 1427.2 | failure, |
| | | | | | | chemical |
| | | | | | | attack |
| Permabond | Clear | AG3014 UV | Pass | 0.0; 0.0 | NT | no bond |
| | | | | | | to glass |
| Permabond | Clear | 683 | Pass | 0.2; 35 | 367.5; | |
| | | | | | 2533.8 | |
| Silicone Sealant | Clear | Silicone Sealant 7.25- | Fail | NT | NT | |
| | | Ounce Can, Clear | | | | |
| STR | Clear | 15580P (HALS free | Pass | 40.0; | NT | |
| | | EVA) | | 7,005 | | |

As can be seen from Table 4, acrylic and silicone based pressure sensitive adhesive systems can provide the desired amount of adhesion and ease of application. Ultraviolet (UV) light cured modified acrylate optical quality adhesives can provide greater bond strength as compared to other adhesive systems. It can be desirable to provide a cap substrate with enough stiffness to overcome the tendency of the cap substrate to curl due to shrinkage of the base substrate for systems with cure temperatures greater than 38° C. for over 10 minutes, such as EVA and TPU. For example, a 0.7 mm glass cap substrate can have sufficient stiffness to overcome the shrinkage of a 0.075 mm base substrate comprising polycarbonate.

The adhesive 6 can be optically clear, such as providing a transmittance of visible light of greater than or equal to 90% as determined per ASTM D1003-00. The adhesive 6 can be opaque, such as colored to match the polymeric resin attachment 30, the cap substrate 4, or the base substrate 8. The base substrate 8 can be opaque. The base substrate 8 can be optically clear such as providing a transmittance of visible light of greater than or equal to 90% as determined per ASTM D1003-00. The adhesive 6 can include a polymer. The polymer of the adhesive 6 can include a thermosetting polymer. The polymer of the adhesive 6 can include a thermoplastic polymer. The thermosetting polymer can be activated by electromagnetic radiation (e.g., electromagnetic radiation in the ultraviolet (UV) spectrum having frequencies of 750 THz to 30 PHz), electron beam, heat, drying, exposure to air, pressure (e.g., pressure sensitive adhesives) or a combination including at least one of the foregoing. The adhesive 6 can be applied between the cap substrate 4 and the base substrate 8 to couple them together so as to prevent separation. When the substrates are coupled in this way the base substrate 8 can exhibit an adhesion to the cap substrate 4 of greater than 3 lb_{f} (pounds force) per linear inch (525 Newtons per meter (N/m)) as determined by a 90 degree peel test. In an embodiment, the adhesive 6 can include a thermal plastic urethane (TPU). In some embodiments, the adhesive 6 can include epoxy, acrylate, amine, urethane, silicone, thermal plastic urethane, ethyl vinyl acetate, HALS free EVA, or a combination including at least one of the foregoing. In an embodiment when the cap substrate 4 has a higher flexural stiffness than the base substrate 8, an adhesive can include TPU, EVA, or both.

The base substrate 8 can include a polymer, a filler material, a polymer additive, or a combination including at least one of the foregoing. The base substrate 8 can have a first surface 14, a second surface 16, and an edge 22. The base substrate 8 can be any shape. The base substrate 8 can be flat. The base substrate 8 can be less than or equal to 6.0 millimeters thick, for example, 0.02 mm to 6.0 mm thick, or, 0.02 mm to 1.0 mm thick, as measured in along the shortest dimension of the base substrate 8 (along the t-axis in the figures). The shape of the base substrate 8 can correspond to the shape of the cap substrate 4, such that when the substrates are coupled (e.g. adhered together), the edges (20, 22) of the substrates (4, 8) are flush with one another (along the w-axis dimension in the figures). For example, the base substrate 8 can be adhered to the cap substrate 4 to form a mold insert 50 which can be cut such that the edges are flush. The adhesive 6 and base substrate 8 can form a border around the perimeter of the cap substrate 4 (e.g., a frame), such that the base substrate 8 and adhesive extend along a portion of a surface of the cap substrate 4. The base substrate 8 can exhibit curvature in a dimension.

The base substrate 8 can be decorated on surfaces 14 and/or 16 and/or the cap substrate can be decorated on surfaces 10 and/or 12 using any of a number of decorating techniques including but not limited to screen printing, pad printing, metallization, digital printing, gravure printing, offset printing, laser marking, laser printing, etching, and texturing.

The base substrate 8, the adhesive 6 and cap substrate 4 can be coupled (e.g. adhered) together to form a mold insert 50. The mold insert 50 can be formed by pressuring the base substrate 8, the adhesive 6, and the cap substrate 4 together, and activating the adhesive 6. For example, the mold insert 50 can be formed in a roll to sheet transfer, stamping, roller pressing, belt pressing including double belt pressing, vacuum bag, autoclave, vacuum lamination, parallel platen lamination, injection mold shut off, or a combination comprising at least one of the foregoing. Pressuring the mold insert 50 can include pressing to a pressure greater than 0.1 megaPascal (MPa), for example 0.1 MPa to 1 MPa, or, 0.2 MPa to 0.5 MPa, or, 34 MPa or greater pressure as with an injection mold shutoff. The mold insert 50 can be formed in a lamination process. The mold insert 50 can be formed such that it exhibits curvature in one or more dimensions, or the mold insert 50 can be flat.

The polymeric resin attachment 30 can be any shape. The polymeric resin attachment 30 can be bonded to the cap substrate 4 by way of the base substrate 8. In this way, a polymeric resin attachment 30 can be bonded with strong adhesion to the base substrate 8 which in turn can be adhered to the cap substrate 4 with strong adhesion (e.g., a adhesion value of 3 lb_{f} per linear inch as determined by a 90 degree peel test or as determined by temperature cycling at −40° C. to 85° C. at 85% RH with 1 hour dwells at each temperature for 10 to 50 cycles, or by submersing the sample in boiling water for between 5 and 20 minutes, and then checking for signs of delamination). The polymeric resin attachment 30 can surround the edge 20 of the cap substrate 4 and the edge 22 of the base substrate 8. The polymeric resin attachments 30 can extend along the edge of the base substrate 8, the adhesive 6, and the cap substrate 4 and can be flush with the first surface 10 of the cap substrate 4 (e.g., in the t-axis dimension of the figures), such that the article 2 is smooth along the front side 58. The polymeric resin attachment 30 can extend along the edges 20, 22 and along the first surface 10 of the cap substrate 4 to form a lip 24, as shown in FIG. 2. The polymeric resin attachment 30 can be separated from the edges 20, 22 by a gap (e.g., such as to allow for thermal expansion of the substrates).

The polymeric resin attachment 30 can be molded to the mold insert 50 in a molding process. For example, the mold insert 50 can be positioned in a mold cavity and a polymeric material of the polymeric resin attachment 30 can be injected into the mold cavity to bond to the base substrate 8 of the mold insert 50. The molding process can incorporate known technologies within the art such as injection molding, injection compression molding, gas assist molding, foam molding, multi shot molding, multi stage molding, compression molding, or a combination including at least one of the foregoing. Tooling that improves flow, surface finish, and weld strength of knit lines within a molded part such as induction heating and heat/cool technology can be used to reduce injection pressures, improve surface finishes, and promote improved bond strength to the mold insert 50. The mold insert 50 can be held in position within the mold cavity during the molding process using any technique known in the art. The mold insert 50 can be held in place by a pressure differential such as vacuum applied to an area of the mold insert 50 through passages in a mold section. The mold insert 50 can be held in place by pins extending from a mold section into the mold cavity. The pins can be spring loaded to ensure sufficient pressure is applied to the mold insert 50 to maintain its position during the molding operation. Spring loaded pins can account for variation in the thickness of the mold insert 50 from part to part during production of multiple articles. The mold insert can be held in place by a static charge. The mold insert can be held in place by core shutoffs that can extend out from the cavity and can form a feature that the insert can fit over. For example, as demonstrated in FIGS. 6A and 6B, protruding features 51 (e.g., pins) located within a mold or tool 53, can be used to assist in aligning the mold insert 50 and the polymeric attachment 30. The mold insert can be held in place by closing the core side of the tool onto the insert and thus creating a shutoff between the core, cavity, and insert over an area or a multitude of areas. The mold insert 50 can be held in place by a combination of pins, static, shutoffs, mold features, and pressure differential as described in the foregoing.

The polymeric resin attachment 30 can include a polymer, a filler material, a polymer additive, or a combination including at least one of the foregoing. A filler material can include reinforcing fiber. The filler material can be in any desirable form for use in a molding operation, such as chopped. The polymeric resin attachment 30 can include 0.1 to 50 weight percent (wt. %) filler material, for example, 5 wt. % to 40 wt. %, or, 15 wt. % to 30 wt. %, or, 20 wt. %. In an embodiment, the polymeric resin attachment 30 can include 5 wt. % to 25 wt. % carbon fiber, or 20 wt. %. In an embodiment, the polymeric resin attachment 30 can include 5 wt. % to 40 wt. % glass fiber or glass bead, or 30 wt. %. Incorporating a filler material can reduce shrinkage of the polymeric resin attachment 30 after a molding operation, which can prevent the article 2 from undesirable warping. When the polymeric resin attachment is molded from unfilled polymeric resin, the molded part can be placed in a fixture after molding to prevent the article 2 from warping.

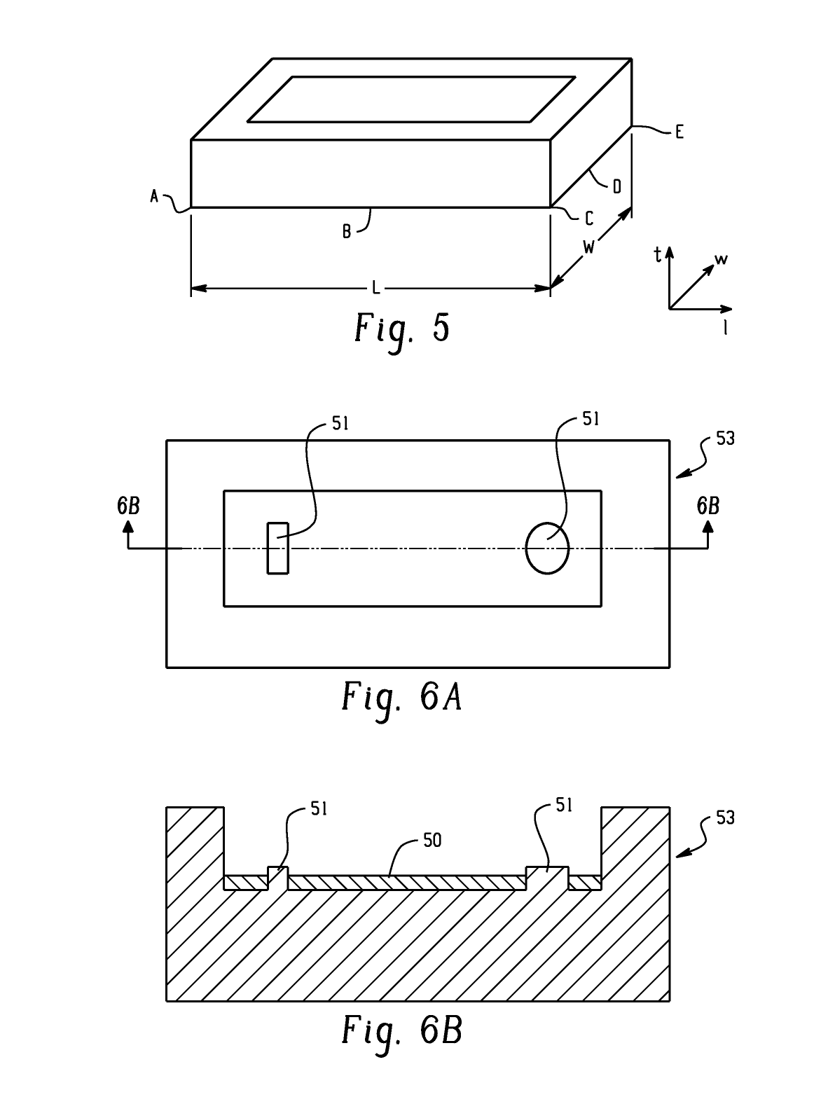

An evaluation of a polymeric resin attachment 30 including a filler material is provided in Table 5. Each of Samples 6 to 11 of Table 5 included a 0.7 or 0.55 mm thick cap substrate 4 of chemically hardened glass (e.g., GORILLA™ glass) or 1 mm thick cap substrate 4 of thermally strengthened (i.e., tempered) glass which was laminated to a 0.075 mm base substrate 8 of polycarbonate with a 0.04 mm thick adhesive of a pressure sensitive adhesive material (PSA). Samples 12 and 13 included a 1.0 mm cap substrate 4 of thermally strengthened (i.e., tempered) glass which was laminated to a 0.127 mm base substrate of polycarbonate with a 0.04 thick PSA. Sample 14 included a 0.1 mm cap substrate 4 of non-strengthened glass which was laminated to a 0.127 mm base substrate of polycarbonate and carbon fiber composite with a 0.04 mm thick PSA. The carbon fiber composite was a two over one twill with 3000 filaments in one bundle (i.e., 3 k carbon) consolidated with polyetherimide at 300 psi (2068.3 kPa) and 700° F. (371° C.). Sample 15 included a 0.55 mm cap substrate 4 of chemically hardened glass (e.g., GORILLA™ glass) which was laminated to a 0.127 mm base substrate of polycarbonate with a 0.04 thick PSA. In all the samples, the polymeric resin attachment 30 formed a 0.3 mm lip 24 around the perimeter of the article 2 on the front side 58, encapsulated the edge 52 of the mold insert 50, and formed a 2 mm perimeter on the second surface 16 of the base substrate 8 opposite the front side 58 (where the attachment was coupled to the base substrate 8). Measurements were taken from the table to the edge of the article at points A-E as shown in FIG. 5, where point A is taken at L=0 and W=0, point B is taken at L=L/2 and W=0, point C is taken at L=L and W=0, point D is taken at L=L and W=W/2, and point E is taken at L=L and W=W.

TABLE 5
Evaluation of Polymeric Resin Attachments Including Filled Resin
Sample 6 (dimensions in mm)
Resin 1: LNP ™ THERMOCOMP ™ Compound DC0041PQ
(20 wt. % carbon fiber filled polycarbonate) with 0.7 mm chemically
strengthened glass substrate

| | | | |
|---|---|---|---|
| A | 0 | D | 0.01 |
| B | 0.03 | E | 0 |

| | |
|---|---|
| C | 0 |

| | |
|---|---|
| Standard Deviation | 0.01 |

Sample 7 (dimensions in mm)
Resin 2: LEXAN ™ 500 R (10 wt. % glass fiber filled polycarbonate)
with 0.7 mm chemically strengthened glass substrate

| | | | |
|---|---|---|---|
| A | 0 | D | 0.25 |
| B | 0.5 | E | 0 |

| | |
|---|---|
| C | 0 |

| | |
|---|---|
| Standard Deviation | 0.2 |

Sample 8 (dimensions in mm)
Resin 3: LEXAN ™ 125R (unfilled polycarbonate) with 0.7 mm
chemically strengthened glass substrate

| | | | |
|---|---|---|---|
| A | 0.5 | D | 1.7 |
| B | 2.3 | E | 0 |

| | |
|---|---|
| C | 0 |

| | |
|---|---|
| Standard Deviation | 0.94 |

Sample 9 (dimensions in mm)
Resin 1 with 0.55 mm chemically strengthened glass substrate

| | | | |
|---|---|---|---|
| A | 0 | D | 0.31 |
| B | 0.23 | E | 0.12 |

| | |
|---|---|
| C | 0.31 |

| | |
|---|---|
| Standard Deviation | 0.12 |

Sample 10 (dimensions in mm)
Resin 4: LNP ™ THERMOCOMP ™ Compound D251 (20% glass
fiber filled polycarbonate) with 0.55 mm chemically strengthened
glass substrate

| | | | |
|---|---|---|---|
| A | 0 | D | 0.25 |
| B | 0.6 | E | 0.111 |

| | |
|---|---|
| C | 0.25 |

| | |
|---|---|
| Standard Deviation | 0.20 |

Sample 11 (dimensions in mm)
Resin 5: LNP ™ THERMOCOMP ™ Compound D452 (40% glass
fiber filled polycarbonate) with 0.55 mm chemically strengthened
glass substrate

| | | | |
|---|---|---|---|
| A | 0 | D | 0.32 |
| B | 0.5 | E | 0.11 |

| | |
|---|---|
| C | 0.3 |

| | |
|---|---|
| Standard Deviation | 0.17 |

Sample 12 (dimensions in mm)
Resin 5: LNP ™ THERMOCOMP ™ Compound D452 (40% glass
fiber filled polycarbonate) with 1 mm heat strengthened glass
substrate

| | | | |
|---|---|---|---|
| A | 0 | D | 0 |
| B | 0 | E | 0 |

| | |
|---|---|
| C | 0 |

| | |
|---|---|
| Standard Deviation | 0 |

Sample 13 (dimensions in mm)
Resin 5: LEXAN ™ 125R (unfilled polycarbonate) with 1 mm heat
strengthened glass substrate

| | | | |
|---|---|---|---|
| A | 0 | D | 0 |
| B | 0.4 | E | 0 |

| | |
|---|---|
| C | 0 |

| | |
|---|---|
| Standard Deviation | 0.16 |

Sample 14 (dimensions in mm)
Resin 5: LNP ™ THERMOCOMP ™ Compound D452 (40% glass
fiber filled polycarbonate) with 0.1 mm non-strengthened glass
substrate

| | | | |
|---|---|---|---|
| A | 0.05 | D | 0.04 |
| B | 0.27 | E | 0 |

| | |
|---|---|
| C | 0 |

| | |
|---|---|
| Standard Deviation | 0.09 |

Sample 15 (dimensions in mm)
Resin 5: LNP ™ THERMOCOMP ™ Compound D452 (40% glass
fiber filled polycarbonate) with 0.55 mm chemically strengthened
glass substrate

| | | | |
|---|---|---|---|
| A | 0 | D | 0.05 |
| B | 0.1 | E | 0 |

| | |
|---|---|
| C | 0 |

| | |
|---|---|
| Standard Deviation | 0.03 |

As can be seen from Table 5, Samples 6, 10, 12, 14, and 15, containing various amounts of either carbon fibers or glass fibers, demonstrated the lowest amount of warpage. Without wishing to be bound by theory, it is believed glass fiber content below 15-30% does not have a significant influence on lowering warpage. As also demonstrated by Table 5, thickness of the glass substrate can have an effect on warpage. For example, a 1 mm thick thermally strengthened glass substrate can give a lower warpage as compared to a 0.7 mm or 0.55 mm thick chemically strengthened or non-chemically strengthened glass substrate. However, thinner glass substrates can be supported and breaking during molding avoided by laminating the thinner glass substrate to a continuous fiber composite.

For example, a fiber composite can be a laminate including an A-B-A structure. The A-B-A structure can comprise a first thermoplastic material; a first outer layer comprising a second thermoplastic material located on a first side of the core layer and in physical contact therewith; a second outer layer comprising the second thermoplastic material located on a second side of the core layer opposite the first side and in physical contact with the core layer; wherein the core layer has a through plane thermal conductivity of greater than equal to 0.1 Watts per meter-Kelvin (W/mK); wherein the thickness of the core layer is 30% to 75% of the total thickness of the A-B-A structure.

Thin-walled A-B-A structures can include a thermoplastic composite construction. The composite construction can include a sandwich construction including outer layers of reinforced material with an inner core of a thermoplastic material which may or may not be reinforced. The inner core can be a solid thermoplastic material or a substantially solid thermoplastic material. The core layer (“B” layer) can be neat (no reinforcement). Alternatively, the core layer can include a reinforcing material. The reinforcing material can include fibers, (continuous, chopped, woven, and the like). The core layer can include 0 to 70 wt. % reinforcing material and 100 to 30 wt. % first thermoplastic material. The core layer can include about 20 to 40 wt. % fibers (e.g., reinforcing material) and 80 to 60 wt. % first thermoplastic material. The core layer can comprise short fibers (e.g. short glass fibers).

The “A” layer can include fabric based composites (e.g., reinforcing material in the form of a fabric in a matrix of the second thermoplastic material). For example, satin harness style weaves and low basis weight “spread tow” fabrics can be used. As used herein low basis weight is less than 50 grams per square meter (gsm). The fabric based composite can have a basis weight of 50 to 500 gsm. The fabric based composite can have a basis weight of 100 to 400 gsm. The fabric based composite can have a basis weight of 200 to 400 gsm.

The second thermoplastic material can include co-mingled, co-woven and stretch broken yarn fabrics. A variety of technical weaves can be used including, but not limited to, plain, twill, basket, leno and satin weaves. The fabric can be a patterned fiber layer, e.g., a patterned fabric within a second material. The pattern of the material can be designed to reduce the amount of fibers (and hence weight), while maintaining strength. Therefore, the “A” layer can be custom designed for the particular application wherein the fibers are oriented to enhance structural integrity in areas that are higher stress during use. Some examples of patterned fabrics include polygonal cells (e.g., hexagonal cells), triangular cells, pentagonal cells), rounded cells, or a combination comprising at least one of the foregoing, e.g., the patterned fabric can be hexagonal cells. In some embodiments, the patterned fabric can be a perforated material. As used herein, a patterned fabric is a tailored pattern that locates fabric where needed in order to attain the strength and stiffness for the application of the article. In some embodiments patterned fabric is not a uniformly repeated pattern. The patterned fabric can be an open weave (e.g., a woven fabric with spaces between adjacent strands). The patterned fabric can have a non-uniform density across the fabric, wherein some areas comprise fabric and others are free of fabric.

The reinforcing material can comprise aramid, carbon, basalt, glass, plastic (e.g., thermoplastic polymer, thermoset polymer), quartz, boron, cellulose, or natural fibers, as well as combinations comprising at least one of the foregoing, such as high stiffness inorganic fibers (e.g., glass, carbon, quartz, boron, and combinations comprising at least one of the foregoing). High stiffness refers to a tensile modulus of greater than or equal to 35 GigaPascals (GPa). For example, the fibers can be formed of liquid crystal polymer, high tenacity polymer (e.g., polypropylene, polyethylene, poly(hexano-6-lactam), poly[imino(1,6-dioxohexamethylene) imnohexamethylene]), as well as combinations comprising at least one of the foregoing. An exemplary fiber filled resin is LEXAN™ resin, commercially available from SABIC Innovative Plastics. Another exemplary fibrous material can include fiber reinforced thermoplastics such as ULTEM™ resins, commercially available from SABIC Innovative Plastics). For example, a variety of reinforcement fibers may be used for the outer layers. For example, E-glass, S-glass and various carbon based systems, and combinations comprising at least one of the foregoing, may be employed, e.g., a glass (e.g. E-glass)-carbon hybrid fabric. The outer layer can have a different reinforcing material than the core layer. Certain enclosure applications may need radio frequency transparency. Thus, glass reinforcement can be used in the outer layer in these applications. An exemplary reinforcing material (e.g., for the outer layers) is Tencate CETEX TC925 FST or Tencate CETEX TC1000 commercially available from Ten Cate Advanced Composites.

The second thermoplastic material can be chemically compatible with the first thermoplastic material to promote adhesion between the outer layers and the core layer. Thus, the use of an adhesive between the core layer and the outer layer can be minimized or completely eliminated. For example, the first thermoplastic material and the second thermoplastic material can have the same base polymer (e.g., polycarbonates with different amounts and/or types of reinforcing material). The viscosity of the first thermoplastic material can be different from the viscosity of the second thermoplastic material. For example, the first thermoplastic material can have a higher viscosity than the second thermoplastic material. Thus, the core layer made from the higher viscosity first thermoplastic material can resist “squeezing out” in preforming operations. The difference in melt flow rate for the second thermoplastic material versus the first thermoplastic material can be such that a melt flow rate of the second thermoplastic material ≧2× melt flow rate of the first thermoplastic material, e.g., melt flow rate of the second thermoplastic material ≧3× melt flow rate of the first thermoplastic material. For example for polycarbonate based materials, second thermoplastic material can have a melt flow rate of greater than or equal to 25 grams per 10 minutes (g/10 min), or greater than or equal to 45 g/10 min, or greater than or equal to 50 g/10 min. The first thermoplastic material can have a melt flow rate of less than or equal to 10 g/10 min. Melt flow rate is determined in accordance with ASTM D1238, using a temperature and weight appropriate for the material of the layers as is specified in the standard.

The first and second thermoplastic materials can include coefficients of thermal expansions that are “matched.” As used herein, “matched” means that a flat A-B-A structure can be formed (e.g., the core layer can be adhered to the outer layers, and once cooled, the structure is not warped. For example, the A-B-A structure can have a bowing that is less than or equal to 2 mm from flat, e.g., less than or equal to 1 mm from flat, or less than or equal to 2 mm from flat, such as no measurable distance from flat (without a microscope). As used herein, “matched” means having a value that differs by less than or equal to 20%. The coefficients of thermal expansion for the first thermoplastic material and the second thermoplastic material can differ by less than or equal to 10%. The coefficients of thermal expansion for the first thermoplastic material and the second thermoplastic material can differ by less than or equal to 5%

The polymeric resin attachment 30 can be molded onto the mold insert 50 and can bond to the base substrate 8 in one or more sections 34. A section 34 can be formed into any shape. A section 34 of the polymeric resin attachment 30 can include a feature, such as an aesthetic feature, tactile feature, strengthening feature, attachment feature and the like, for example, the section 34 can include a logo, insignia, emblem, badge, rib, boss, snap fit, attachment point, energy absorbing structure, cavity, aperture, stud, surface finish, opaque, transparent, or semi-transparent thickness layer and the like.

In an embodiment, the polymeric resin attachment 30 can include a carbon fiber filled polycarbonate, the base substrate 8 can include a polycarbonate film, and the cap substrate 4 can include glass, such as cut chemically strengthened glass. Cut glass can contain a micrometer sized flaw (microflaw), regardless of the polishing and finishing techniques that can be used to minimize them. In an embodiment, the cap substrate 4 can include glass and the polymeric resin attachment 30 can be molded to the base substrate 8 such that the polymeric resin attachment 30 extends along a portion of the second surface 16 of the base substrate 8, along the edge 52 of the mold insert 50 (e.g., along the edge 22 of the base substrate 8, and along the edge 20 of the cap substrate 4), such that it forms a protective barrier surrounding the edge 20 of the cap substrate 4. In this way, if the cap substrate 4 is glass it can be protected by the polymeric resin attachment 30 which can fill and strengthen a microflaw and protect the glass from direct impact along the edge 20, where it can be prone to cracking, fracture, chipping, or other failure if directly impacted (e.g., due to microflaw propagation). In an embodiment, the polymeric resin attachment 30 can form a flush joint 18 with the first surface 10 of the cap substrate 4, such that the outer surface of the article is smooth which can be a desirable aesthetic.

In an embodiment, the article can include a base substrate comprising a glass-filled polycarbonate in-mold decorated with a glass cap substrate (e.g., a glass laminate comprising chemically strengthened glass or thermally strengthened glass). In-mold glass locating tabs (e.g., pins as illustrated in FIGS. 6A and 6B) can be machined directly into the tool with the desired draft angles of 1 to 5 degrees to align the glass cap substrate in the tool for in-mold decoration. In an embodiment, a perimeter of the cap substrate can be coated with a powder (e.g., a polymer powder), i.e., a polymeric resin attachment. In an embodiment, a perimeter of the cap substrate can be coated with an adhesive (e.g., a UV curing adhesive), i.e., a polymeric resin attachment. In an embodiment, a perimeter of the cap substrate can be coated with a power and an adhesive, i.e., a polymeric resin attachment. In this case, a base substrate is an optional component. The powder can assist in providing the desired adhesion between the cap substrate and the polymeric resin attachment. In an embodiment, a perimeter of the cap substrate can be laminated with a polymer film (i.e., a polymeric resin attachment) and optionally the base substrate only on the perimeter to assist in adhesion between the cap substrate and the base substrate during molding (e.g., in-mold decorating of the cap substrate to the base substrate). In an embodiment, a metallic material can be embedded in a corner, edge, or along a perimeter of the base substrate to provide reinforcement to the article or to provide an antenna for the article. In an embodiment, fabric reinforcement as previously described herein can be used to increase stiffness for cap substrates having a thickness of less than or equal to 150 micrometers (μm). In an embodiment, ultrasonic welding can be used to bond the cap substrate to various base substrates. For example, a glass laminate cap substrate can be ultrasonically welded to a polyetherimide (e.g., ULTEM™) using a 0.075 to 0.130 mm polycarbonate copolymer film (e.g., LEXAN™ FST).

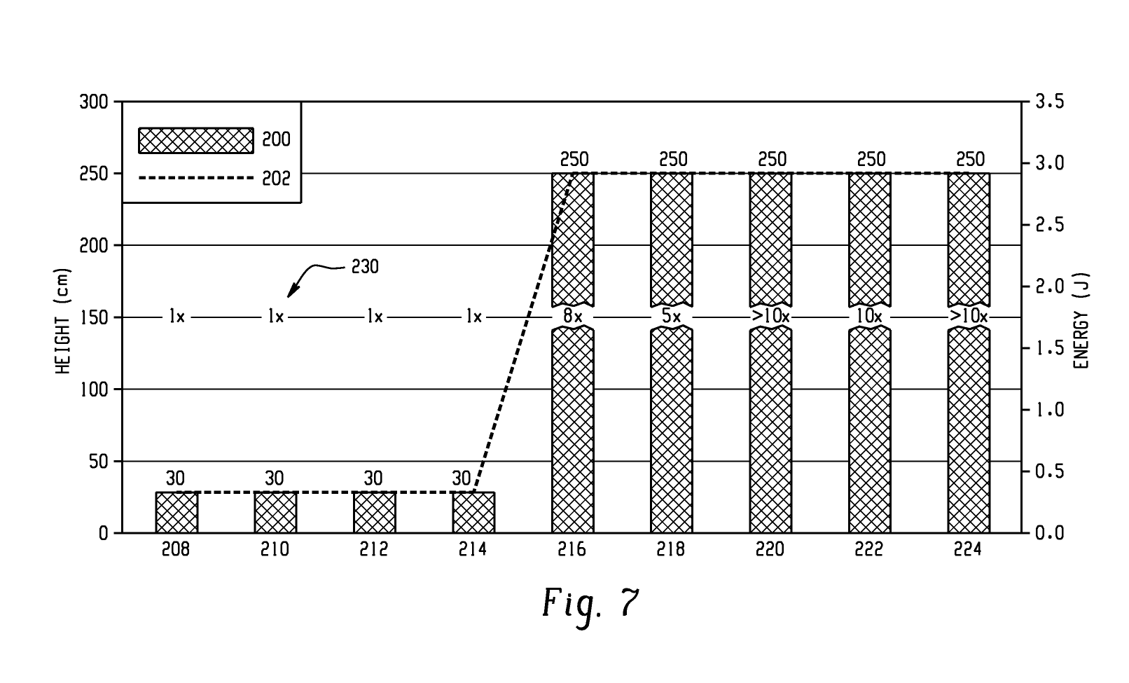

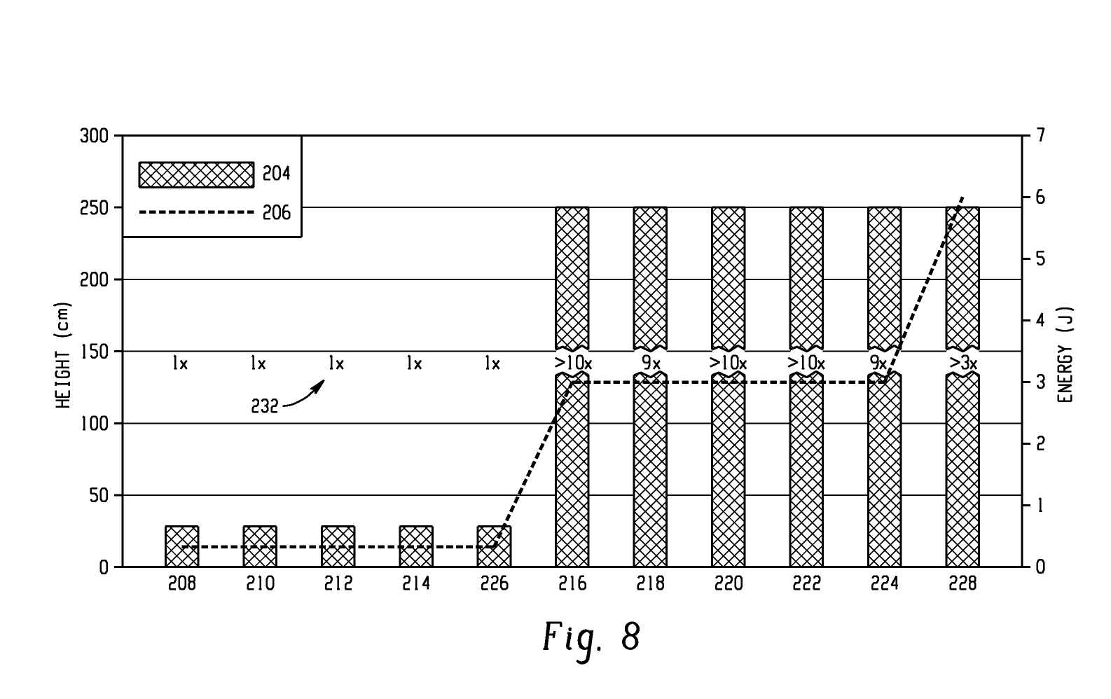

An evaluation of the potential increase in performance for a chemically strengthened glass cap substrate 4 with an edge 20 encapsulated with resin 30 was performed and the results are shown in FIG. 7 and FIG. 8. FIG. 7 illustrates the results from a flat face drop test, while FIG. 8 illustrates the results from a 30° angle face drop test where height, measured in centimeters (cm) and energy, measured in Joules (J) are illustrated. The number of drops to failure is also indicated in FIGS. 7 and 8 along the data at 230 and 232. In the case of samples with the edge of the cap substrate 20 encapsulated with resin 30 (Samples 216, 218, 220, 222, 224, 228), the resin used was LNP™ THERMOCOMP™ Compound D452 (40% glass fiber filled polycarbonate) and the glass cap substrate 4 was 0.55 mm chemically strengthened glass bonded to a base layer 8 of 0.075 mm polycarbonate with 0.04 mm thick PSA adhesive 6. In the case of the samples with no edge encapsulation (208, 210, 212, 214, 226), a 0.55 mm thick chemically strengthened glass was mounted to a bezel molded from LNP™ THERMOCOMP™ Compound D452 (40% glass fiber filled polycarbonate) with a 0.04 mm thick PSA adhesive. In other words, the edges of Samples 208, 210, 212, 214, and 226 were not protected by encapsulation or a plastic bezel meaning that the glass protrudes vertically upward from the surface of the part by a height equal to the thickness of the glass. A 123 gram aluminum weight was attached to the samples to simulate the weight of a cellular phone. As can be seen in FIGS. 7 and 8, the results show an improvement in drop height and the number of drops to failure by encapsulating the edge of the glass cap substrate.

FIGS. 3-4 illustrate an article of manufacture 102 including a mold insert 150 and a polymeric resin attachment 130. The mold insert 150 can include a cap substrate 104, an adhesive 106, and a base substrate 108. An optional functional layer 140 can be disposed between the base substrate 108 and the cap substrate 104 of the mold insert 150. The optional functional layer 140 can be adjacent to the adhesive 106 and a first surface 114 of the base substrate 108. The optional functional layer 140 can be adjacent to a second surface 116 of the base substrate 108. The adhesive 106 can include the functional material of an optional functional layer 140, e.g., ultraviolet light absorbing material. The base substrate 108 can include the functional material of an optional functional layer 140, e.g., ultraviolet light absorbing material. A functional layer 140 can include an image forming layer which can be printed onto a first surface 110 of the cap substrate 104, a second surface 112 of the cap substrate 104, the first surface 114 of the base substrate 108, or the second surface 116 of the base substrate 108, or a combination including at least one of the forgoing. Any desirable printing process can be used, for example, screen printing, digital printing, transfer printing, and the like. In an embodiment, the optional functional layer 140 can be an ink image applied to the second surface 112 of the cap substrate 104 or to the first surface 114 of the base substrate 108 such that the ink image is sandwiched between the cap substrate 104 and the base substrate 108. Covering the ink image in this way can offer protection to the ink image from both the front side and back side of the article, such that the covered ink cannot be removed without damaging the article. In an embodiment, a conductive coating as described herein can be coupled to the second surface 112 of the cap substrate 104 and an image forming layer can be coupled to a first surface 114 of a base substrate 108.

In an embodiment, the cap substrate 4 can include 0.05 mm to 0.2 mm non-strengthened glass bonded with a 0.25 to 0.75 mm (e.g., 0.41 mm) thick silicon based PSA adhesive 106 to a 0.05 to 0.2 mm (e.g., 0.125 mm) thick polycarbonate base substrate 108 bonded with a 0.25 to 0.75 mm (e.g., 0.41 mm) thick silicon based PSA adhesive to a carbon fiber composite functional layer 140. The carbon fiber composite layer 140 can function as a stiffener allowing for injection molding resin 130 onto the insert 150 without breaking the cap substrate 4. The polymeric resin attachment 130 can be molded to the mold insert 150 in a molding process. For example, the mold insert 150 can be positioned in a mold cavity and a polymeric material of the polymeric resin attachment 130 can be injected into the mold cavity to bond to the base substrate 108 of the mold insert 150. The polymeric resin attachment 130 can be molded onto the mold insert 150 and can bond to the base substrate 108 in one or more sections 134. A section 134 can be formed into any shape. A section 134 of the polymeric resin attachment 130 can include a feature, such as an aesthetic feature, tactile feature, strengthening feature, attachment feature and the like, for example, the section 34 can include a logo, insignia, emblem, badge, rib, boss, snap fit, energy absorbing feature, attachment point, cavity, aperture, stud, surface finish, opaque, transparent, or semi-transparent thickness layer and the like.

In an embodiment, the optional functional layer 140 can include a conductive coating as is described in International Application No. PCT/IB2015/052885 and International Application No. PCT/IB2015/02884, the entirety of each is incorporated herein by reference. Furthermore, the conductive coating can be transferred to a base substrate 108 with a transfer resin as described in International Application No. PCT/IB2015/052885. For example, the functional layer can include a conductive coating formed from conductive nanoparticles, including conductive nanoparticles, conductive metal nanowires, carbon allotropes such as carbon nanotubes, graphene, etc., and combinations comprising at least one of the foregoing. Metal nanoparticles can include copper and silver nanoparticles. A metal mesh film can be used having a regular network. Transmittance can be about 70 to about 80% and resistance, measured in Ohm/square can be less than 0.5. Conductive coatings can be formed from conductive metal nanoparticles formed into a patterned network of conductive traces and transparent cells, i.e., voids having few nanoparticles. The network can be random or regular in shape, the transmittance can be about 70%, and the resistance can be less than 0.05 Ohm/square. The transparent cells can have sizes of less than 1 mm, for example, less than 0.5 mm, for example, less than 0.25 mm. Transparent conductive coatings are described, for example, in U.S. Pat. No. 7,601,406.

The conductive coating (e.g., conductive metal nanoparticle layers) can be applied to a substrate by several techniques, including, printing of conductive inks (e.g., flexographic, screen printing, inkjet, gravure), coating and patterning of e.g., silver halide emulsions which can be reduced to silver particles, coating of conductive nanowire dispersions, and self-assembly of silver nanoparticle dispersions or emulsions.

The conductive coating can contain an EMI shielding material. The conductive coating can include pure metals such as silver (Ag), nickel (Ni), copper (Cu), or similar shielding metal, metal oxides thereof, combinations comprising at least one of the foregoing, and metal alloys comprising at least one of the foregoing, or metals or metal alloys produced by the Metallurgic Chemical Process (MCP) described in U.S. Pat. No. 5,476,535. Metal particles of the conductive coating can be nanometer sized, e.g., such as where 90% of the particles can have an equivalent spherical diameter of less than 100 nanometers (nm). The metals of the conductive coating can form a network of interconnected metal traces defining openings on the substrate surface to which it is applied. The surface resistance of the conductive coating can be less than or equal to 1.0 ohm per square (ohm/sq). A conductive coating can have an EMI shielding effectiveness from 30 megahertz (MHz) to 1.5 gigahertz (GHz) as determined per ASTM D4935 of greater than 25 decibel (dB), for example, 30 dB to 80 dB, or, 40 dB to 80 dB. The conductive coating can include carbon based particles arranged in a network, e.g., carbon based particle with a metal mesh. The conductive coating including carbon based particles can be arranged in a regular network. The conductive coating including carbon based particles can be arranged in an irregular network. The carbon based particles can include graphene, carbon nanotubes, or a combination comprising at least one of the foregoing.

The article can transmit greater than or equal to 50% (e.g. 50 percent transmittance) of incident visible light (e.g., electromagnetic radiation (EMR) having a frequency of 430 THz to 790 THz) through a cross section, for example, 60% to 100%, or, 70% to 100%. A transparent polymer, substrate, adhesive, and/or material of the article can transmit greater than or equal to 50% of incident visible light, for example, 75% to 100%, or, 90% to 100%. Percent transmittance for laboratory scale samples can be determined using ASTM D1003-00, Procedure A, using a Haze-Gard test device. ASTM D1003 (Procedure A, Hazemeter, using Standard Illuminant C or alternatively Illuminant A with unidirectional illumination with diffuse viewing) defines percent transmittance as:

$$\% T = ( \frac{I}{{I}_{o}} ) \times 100 \% \qquad [ 1 ]$$

wherein: I=intensity of the light passing through the test sample
   I₀=Intensity of incident light.

The article disclosed herein can successfully pass an industry standard push-out test. Such a push out test can involve applying a load onto a surface (16, 116) of the base substrate (8, 108) while simultaneously resisting this load at an interface (60, 160) of the polymeric resin attachment (30, 130) (e.g., along the front side (58, 158)) in an attempt to disconnect the mold insert (50, 150) from the polymeric resin attachment (30, 130). The applied load can be greater than or equal to 1 lb_{f} (4.4 N), for example 1 lb_{f} to 3 lb_{f} (4.4 N to 13.3 N), or greater than or equal to 5 lb_{f} (22.2 N). The article can successfully pass a thermal cycling test. A thermal cycling test can include subjecting the article to a temperature of −40° C. for 60 minutes, then increasing the temperature at a rate of 3-5° C./minute until the article reaches a temperature of 85° C. where it is maintained for 60 minutes, followed by decreasing the temperature at a rate of 3-5° C./minute until the article reaches a temperature of −40° C. This cycling can be repeated for 10 to 100 cycles. Once completed, the degree to which the polymeric resin attachment is separated from the mold insert is determined. A passing result includes an absence of delamination between base substrate (8, 108) and cap substrate (4, 104) and at the interface (60, 160). The article can pass a 90 degree peel test where the mold insert (50, 150) is peeled at a 90 degree angle relative to a surface where the polymeric resin attachment (30, 130) is coupled to the mold insert (50, 150) with a force of greater than or equal to 5 lb_{f} per linear inch (875 N/m).

The disclosed article can find wide use in any application where it can be desirable to mold a polymeric resin attachment to a cap substrate material. Applications can include electronic devices (e.g., mobile phones, laptop computers, electronic tablets, e-readers, televisions, computer monitors, touch displays, and the like), automotive components, home appliances, refrigerator shelves, medical devices, office furniture, building materials, construction materials, eye wear, face shields, and the like. For example, these articles can be used in housings, bezels, control panels, display panels, windows, covers, trim pieces, support elements, and the like. In some embodiments these articles can be used in any window applications, such as for electronic devices, buildings, vehicles, home appliances, medical devices, and the like. In an embodiment, the article can form a housing for an electronic device where an electronic component is disposed within the article (e.g., a mobile phone, electronic tablet, e-reader, and the like). In an embodiment, the article can form an automotive interface such as a radio bezel, heat/ventilation/air conditioner bezel (e.g, heating vent bezel, ventilation bezel, air conditioning bezel, or the like), rocker button, instrument cluster, or a combination including at least one of the foregoing.

The polymer of the base substrate can include a thermoplastic polymer, a thermoset polymer, or a combination comprising at least one of the foregoing. The polymer of the polymeric resin attachment can include a thermoplastic polymer, a thermoset polymer, or a combination comprising at least one of the foregoing. A polymer of the base substrate can include a polymer of the polymeric resin attachment, for example, the base substrate can include a polycarbonate copolymer and the polymeric resin attachment can include polycarbonate. The first and second thermoplastic materials of the A-B-A structure composite can include a thermoplastic polymer, a thermoset polymer, or a combination comprising at least one of the foregoing

Possible thermoplastic polymers include, but are not limited to, oligomers, polymers, ionomers, dendrimers, copolymers such as graft copolymers, block copolymers (e.g., star block copolymers, random copolymers, and the like) or a combination comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluorides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination comprising at least one of the foregoing.

More particularly, a thermoplastic resin can include, but is not limited to, polycarbonate resins (e.g., LEXAN™ resins, including LEXAN™ CFR resins, commercially available from SABIC's Innovative Plastics business), polyphenylene ether-polystyrene resins (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate resins (e.g., XENOY™ resins, commercially available from SABIC's Innovative Plastics business), copolyestercarbonate resins (e.g., LEXAN™ SLX resins, commercially available from SABIC's Innovative Plastics business), or a combination comprising at least one of the foregoing resins. Even more particularly, the thermoplastic resins can include, but are not limited to, homopolymers and copolymers of a polycarbonate (e.g., LEXAN™ FST), a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer, polycarbonate-dimethyl bisphenol cyclohexane (DMBPC) polycarbonate copolymer (e.g., LEXAN™ DMX and LEXAN™ XHT resins commercially available from SABIC's Innovative Plastics business), polycarbonate-polyester copolymer (e.g., XYLEX™ resins, commercially available from SABIC's Innovative Plastics business)), linear polycarbonate, branched polycarbonate, end-capped polycarbonate (e.g., nitrile end-capped polycarbonate), or a combination comprising at least one of the foregoing, for example, a combination of branched and linear polycarbonate.

A polymer of the base substrate, of the polymeric resin attachment or of both the base substrate and the polymeric resin attachment can include a filler material such as reinforcing fiber (e.g., carbon fiber filled polycarbonate resin such as LNP™ THERMOCOMP™ Compound, commercially available from SABIC's Innovative Plastics business),

A polymer of the base substrate and/or of the polymeric resin attachment can include various additives ordinarily incorporated into polymer compositions of this type, with the proviso that the additive(s) are selected so as to not significantly adversely affect the desired properties of the polymeric composition, in particular hydrothermal resistance, water vapor transmission resistance, puncture resistance, and thermal shrinkage. Such additives can be mixed at a desirable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. The total amount of additives (other than any impact modifier, filler, or reinforcing agents) is generally 0.01 to 5 wt. %, based on the total weight of the composition.

Light stabilizers and/or ultraviolet light (UV) absorbing stabilizers can also be used. Exemplary light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or combinations comprising at least one of the foregoing light stabilizers. Light stabilizers are used in amounts of 0.01 to 5 parts by weight, based on 100 parts by weight of the total composition, excluding any filler.

UV light absorbing stabilizers include triazines, dibenzoylresorcinols (such as TINUVIN™ 1577 commercially available from BASF and ADK STAB LA-46 commercially available from Asahi Denka), hydroxybenzophenones; hydroxybenzotriazoles; hydroxyphenyl triazines (e.g., 2-hydroxyphenyl triazine); hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with a particle size less than or equal to 100 nanometers, or combinations comprising at least one of the foregoing UV light absorbing stabilizers. UV light absorbing stabilizers are used in amounts of 0.01 to 5 parts by weight, based on 100 parts by weight of the total composition, excluding any filler.

### EXAMPLES

A set of multi-span flexural tests were conducted to assess the effectiveness of the A-B-A constructions. A thin wall sandwich composite consisting of single ply 0.25 mm Tencate CETEX TC 925 FST outer layers (7581 style E-glass fabric in a polycarbonate matrix, with a 50 vol % loading, and a thickness of 0.24 mm) and a 0.50 mm unreinforced LEXAN™ 8B35 core was laminated in a vacuum assisted press. Total laminate thickness was 1.00 mm and core/outer layer thickness ratio was 0.50. Nominal flexural dimensions were 25 mm×100 mm. Samples were tested at four spans to eliminate geometric and shear related effects. Samples were also taken in three orientations to test for anisotropy. Specifically, flexural samples were machined in directions that correspond to the “warp”, “weft” and “off” orientations of the outer layers. TC 925 FST uses a 7581 E-glass fabric. This is an 8 harness satin with a relatively “balanced” structure. Directional samples were produced to aid in the understanding of laminate anisotropy. An identical set of samples and tests were run on as-produced 1.00 mm CETEX TC 925 FST laminates. These 4-layer through-thickness controls represent the maximum achievable properties with this combination of resin (PC) and reinforcement (7581 style E-glass fabric). Results are shown in Table 1.

TABLE 6
Flexural Modulus Comparison,
1.00 mm PC/E-glass (66 Wt. %) Laminates
Multi-span 3 Pt. Flexural Moduli [GPa]

| | | 3 Pt. Flexural Span [mm] | | | | Average | % of |
|---|---|---|---|---|---|---|---|
| | | 40 | 50 | 60 | 70 | [GPa] | Thru |
| PC/E-glass ABA | Warp | 17.49 | 20.12 | 20.42 | 20.42 | 19.61 | 75.4% |
| | Weft | 15.20 | 15.83 | 16.65 | 16.65 | 16.08 | 85.7% |
| | Off | 11.36 | 11.88 | 11.67 | 11.67 | 11.65 | 83.2% |
| PC/E-glass thru | Warp | 23.24 | 26.17 | 27.34 | 27.34 | 26.02 | |
| | Weft | 16.94 | 18.77 | 19.67 | 19.67 | 18.77 | |
| | Off | 13.49 | 14.01 | 14.23 | 14.23 | 13.99 | |

Note:
“A” layers are 0.25 mm Tencate CETEX TC 925 FST.
“B” is 0.50 mm LEXAN 8B35 unreinforced PC film

Mathematical models proposed by Johnson and Sims¹ predict flexural moduli that are 87% of through thickness values (assuming core/total thickness ratio=0.50). Experimental results are close to these predictions. Data and theory support the concept that through thickness composites are not required to create stiff thin structures for use in electronic enclosures. The immediate benefits are lighter weight and lower costs. In this instance, 50% of the composite laminate is removed from the core with a modest 15%-20% reduction in stiffness.

Additional characterization work was done to verify the utility of A-B-A laminates in a laptop cover loading scenario. 220 mm×335 mm laminates of the constructions described in Table 2 were tested in a center loaded plate fixture (FIG. 15). A 100 Newton (N) load was applied to the center of the fully supported plate using a 13 mm circular loading nose. Laminates were tested with the long plate dimension (335 mm) aligned with the “warp” and “weft” directions of the CETEX TC 925 FST outer layers. In addition, a third laminate was taken in the “off” direction—a 45 degree offset from warp and weft. Samples were preloaded to 7 N to remove residual laminate “twist”. Final deflections reflect movement after application of an additional 93 N. Similar procedures were used for A-cover qualification by laptop manufacturers. Results are shown in Table 7.

TABLE 7
Centerpoint Plate Deflections, 100 N Load/220 mm × 335 mm Panel

| | CETEX A-B-A¹ | | | CETEX Thru² | | | Al |
|---|---|---|---|---|---|---|---|
| | Overall Thickness | | | | | | |
| | | | | 1.00 mm, | | 1.50 mm, | |
| Sample | | | | As- | 1.00 mm, | As- | |
| Description | 1.00 mm | 1.25 mm | 1.40 mm | produced | Off-core | Produced | 0.65 mm |
| Warp, Side 1 | 6.34 | 6.24 | 6.22 | 5.44 | 5.40 | 4.26 | 4.20 |
| Warp, Side 2 | 6.60 | 6.25 | 5.86 | 5.33 | 5.44 | 4.56 | 3.99 |
| Weft, Side 1 | 6.78 | 6.39 | 5.96 | 5.75 | 5.43 | 4.56 | |
| Weft, Side 2 | 6.26 | 5.98 | 5.97 | 5.46 | 5.26 | 4.13 | |
| Off, Side 1 | 6.34 | 6.33 | 6.23 | 5.98 | 5.37 | 4.38 | |
| Off, Side 2 | 6.85 | 6.42 | 6.06 | 5.59 | 5.15 | 4.60 | |
| Average | 3.53 | 6.27 | 6.05 | 5.59 | 5.34 | 4.42 | |
| Std. Dev. | 0.25 | 0.16 | 0.15 | 0.24 | 0.11 | 0.19 | |
| Deflection | 16.8% | | | | | | |
| Increase | | | | | | | |

¹A layer is CETEX having a thickness of 0.24 mm.
²Through thickness is a CETEX multilayer sheet.
³Aluminum sheet.
Side 1 and Side 2 refer to the same sample being tested on both sides (tested, flipped, and retested). The difference in the results is due to any warpage/bow in the construction.

Deflection of fully supported CETEX TC925 FST A-B-A constructions at 1.00 mm thickness (core/skin ratio of 0.50) is 17% larger than through thickness deflection. This is consistent with flexural results and further evidence of the benefits of A-B-A constructions for thinwall electronic enclosures. Fully supported plate bending is more complicated than simple flexural loading, because large in-plane tensile stresses are often present. The relatively “thick” outer layers that are specified in this document are better able to handle tensile stresses than “thin” skins that are used in traditional A-B-A constructions. This distinction is supported by the experimental results in Table 2. Data in this table also shows that substantial increases in core thickness (40%) rapidly meet with diminishing returns, e.g. lower deflections, at the wall thicknesses required for electronic enclosures. The core-thickness ratios that are described in the embodiments offer a good balance of stiffness and cost/weight reduction.

The integrated conductive film as disclosed herein can be used in any electronic device having a touch sensing device. For example these integrated conductive films can be used in electronic displays such as televisions, desktop computer displays, public information displays, educational displays, automotive displays, smart windows; mobile electronic devices such as cell phones, portable computers, tablets, wearable electronic devices, such as watches, bands, portions of clothing or other textiles incorporating electronics including touch sensing features; transparent EMI shielding applications, and capacitive sensing applications (such as applications having touch sensing controls).

Unless otherwise specified herein, any reference to standards, regulations, testing methods and the like, such as ASTM D1003, ASTM D3359 refer to the standard or method that is in force at the time of filing of the present application.

The articles and methods disclosed herein include at least the following embodiments:

### Embodiment 1

An article of manufacturing comprising: a mold insert comprising: a cap substrate having a first surface and a second surface; an adhesive coupled to a portion of the second surface of the cap substrate; a base substrate having a first surface and a second surface, wherein the first surface of the base substrate is coupled to the adhesive, wherein the adhesive is disposed between the second surface of the cap substrate and the first surface of the base substrate; and a polymeric resin attachment, wherein the polymeric resin attachment is coupled to a portion of the second surface of the base substrate, wherein the polymeric resin extends along an edge of the base substrate, and along an edge of the cap substrate.

### Embodiment 2

The article of Embodiment 1, wherein a front side of the article comprises the first surface of the cap substrate and a portion of the polymeric resin attachment, and wherein the first surface of the cap substrate and the polymeric resin attachment are flush along the front side of the article.

### Embodiment 3

The article of any of Embodiments 1-2, wherein the polymeric resin attachment comprises filler material, and wherein the filler material comprises carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), or a combination comprising at least one of the foregoing.

### Embodiment 4

The article of any of Embodiments 1-3, wherein the polymeric resin attachment comprises carbon fiber in an amount of 5 wt. % to 25 wt. % of the total weight of the polymeric resin attachment.

### Embodiment 5

The article of any of Embodiments 1-4, wherein the polymeric resin attachment comprises glass fiber in an amount of 5 wt. % to 40 wt. % of the total weight of the polymeric resin attachment.

### Embodiment 6

The article of any of Embodiments 1-5, wherein the polymeric resin attachment comprises glass bead in an amount of 5 wt. % to 40 wt. % of the total weight of the polymeric resin attachment.

### Embodiment 7

The article of any of Embodiments 1-6, wherein the cap substrate comprises a glass, a wood, a metal, a fiber sheet, or a combination comprising at least one of the forgoing.

### Embodiment 8

The article of any of Embodiments 1-7, wherein the cap substrate comprises glass and the cap substrate has a thickness as measured along the shortest dimension of the cap substrate of 0.05 mm to 1 mm.

### Embodiment 9

The article of any of Embodiments 1-8, wherein the cap substrate comprises chemically strengthened glass and the cap substrate has a thickness as measured along the shortest dimension of 0.3 mm to 1 mm, for example, 0.4 mm to 1 mm.

### Embodiment 10

The article of any of Embodiments 1-9, wherein the cap substrate comprises non-strengthened glass and the cap substrate has a thickness as measured along the shortest dimension of 0.05 mm to 0.3 mm, for example, 0.1 mm to 0.2 mm.

### Embodiment 11

The article of any of Embodiments 1-10, wherein the cap substrate comprises an optically transparent synthetic crystal (e.g., Sapphire glass) and the cap substrate has a thickness as measured along the shortest dimension of 0.06 mm to 2 mm, for example, 0.6 mm to 0.7 mm

### Embodiment 12

The article of any of Embodiments 1-11, wherein the base substrate comprises polycarbonate, polyester, polypropylene, polyetherimide, poly(methyl methacrylate), polycarbonate-dimethyl bisphenol cyclohexane, polyestercarbonate, or a combination comprising at least one of the foregoing.

### Embodiment 13

The article of any of Embodiments 1-12, further comprising a functional layer, wherein the functional layer is disposed between the adhesive and the first surface of the base substrate.

### Embodiment 14

The article of any of Embodiments 1-13, further comprising a functional layer, wherein the functional layer is disposed between the adhesive and the second surface of the cap substrate.

### Embodiment 15

The article of any of Embodiments 1-14, wherein the polymeric resin attachment forms a border that surrounds the mold insert in at least one dimension.

### Embodiment 16

The article of any of Embodiments 1-15, wherein the adhesive comprises epoxy, acrylate, amine, urethane, silicone, thermal plastic urethane, ethyl vinyl acetate, HALS free EVA, or a combination comprising at least one of the foregoing.

### Embodiment 17

The article of any of Embodiments 1-16, wherein the base substrate comprises an A-B-A structure, comprising: a core layer comprising a first thermoplastic material having a first density (Y), wherein the core layer has a core thickness and wherein the core layer comprise at least one of (i) a through plane thermal conductivity of greater than equal to 0.1 W/mK, and (ii) a core layer density (X) that is X≧0.8 Y; a first outer layer comprising a second thermoplastic material located on a first side of the core layer; and a second outer layer comprising the second thermoplastic material located on a second side of the core layer opposite the first side; wherein the core thickness is 30% to 75% of a total thickness of the A-B-A structure.

### Embodiment 18

The structure of Embodiment 17, wherein the first outer layer comprises greater than or equal to 35 vol. % reinforcing material based upon a total weight of the first outer layer, preferably 35 vol. % to 70 vol. % reinforcing material, or 40 vol. % to 60 vol. % reinforcing material; and wherein the second outer layer comprises greater than or equal to 35 vol. % reinforcing material based upon a total weight of the second outer layer, preferably 35 vol. % to 70 vol. % reinforcing material, or 40 vol. % to 60 vol. % reinforcing material.

### Embodiment 19

The structure of Embodiment 17 or Embodiment 18, wherein the reinforcing material is a fabric; preferably, wherein the reinforcing material is a patterned fabric.

### Embodiment 20

The structure of Embodiment 19, wherein the reinforcing material is the patterned fabric and the patterned fabric comprises at least one of (i) a patter that is not a uniformly repeated pattern; (ii) an open weave fabric; (iii) a fabric having a non-uniform density across the fabric; and (iv) a tailored pattern with fabric where needed in order to attain the strength and stiffness for the application of the article; preferably, wherein the reinforcing material is the patterned fabric and the patterned fabric comprises at least one of (i) a pattern that is not a uniformly repeated pattern; and (ii) an open weave fabric; (iii) a fabric having a non-uniform density across the fabric.

### Embodiment 21

The structure of Embodiment 19, wherein the reinforcing material is the patterned fabric and the patterned fabric comprises a patter that is not a uniformly repeated pattern.

### Embodiment 22

The structure of Embodiment 19, wherein the reinforcing material is the patterned fabric and the patterned fabric comprises an open weave fabric.

### Embodiment 23

The structure of Embodiment 19, wherein the reinforcing material is the patterned fabric and the patterned fabric comprises a fabric having a non-uniform density across the fabric

### Embodiment 24

A housing for an electronic device comprising the article of any of Embodiments 1-23.

### Embodiment 25

An electronic device comprising an electronic component and the article of any of Embodiments 1-24, wherein the electronic component is housed inside the article.

### Embodiment 26

The electronic device of Embodiment 25, wherein the electronic device comprises a mobile phone, electronic tablet, e-reader, lap top, desk top, speaker, or a combination comprising at least one of the foregoing.

### Embodiment 27

A shelf for an appliance comprising the article of any of Embodiments 1-23.

### Embodiment 28

A face shield comprising the article of any of Embodiments 1-23.

### Embodiment 29

An automotive interface comprising the articles of any of Embodiments 1-23, wherein the automotive interface comprises a radio bezel, heating vent bezel, ventilation bezel, air conditioner vent bezel, rocker button, instrument cluster, or a combination comprising at least one of the foregoing.

### Embodiment 30

A method for forming an article of manufacturing comprising: applying an adhesive to a surface of a first substrate; coupling a second substrate to the adhesive to form a mold insert, wherein the adhesive is sandwiched between the first substrate and the second substrate; molding a polymeric resin attachment to the mold insert in an injection molding process to form an article; wherein the polymeric resin attachment is coupled to a portion of one of the first substrate and second substrate, and wherein the polymeric resin attachment extends along a portion of an edge of the mold insert.

### Embodiment 31

The method of Embodiment 30, further comprising applying a functional layer to one of the first substrate and second substrate.

### Embodiment 32

The method of any of Embodiments 30-31, further comprising mixing a functional material with the adhesive.

### Embodiment 33

The method of any of Embodiments 30-32, further comprising printing an image onto a second surface of one of the first substrate or second substrate; wherein the image is disposed between the first substrate and the second substrate.

### Embodiment 34

The method of any of Embodiments 30-33, further comprising housing an electronic component within the article.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. An article of manufacturing comprising:
a mold insert comprising:
a cap substrate having a first surface and a second surface;
an adhesive coupled to a portion of the second surface of the cap substrate;
a base substrate having a first surface and a second surface, wherein the first surface of the base substrate is coupled to the adhesive, wherein the adhesive is disposed between the second surface of the cap substrate and the first surface of the base substrate; and
a polymeric resin attachment, wherein the polymeric resin attachment is coupled to a portion of the second surface of the base substrate, wherein the polymeric resin extends along an edge of the base substrate, and along an edge of the cap substrate.

2. The article of claim 1, wherein a front side of the article comprises the first surface of the cap substrate and a portion of the polymeric resin attachment, and wherein the first surface of the cap substrate and the polymeric resin attachment are flush along the front side of the article.

3. The article of claim 1, wherein the polymeric resin attachment comprises filler material, and wherein the filler material comprises carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), or a combination comprising at least one of the foregoing.

4. The article of claim 1, wherein the polymeric resin attachment comprises carbon fiber in an amount of 5 wt. % to 25 wt. % of the total weight of the polymeric resin attachment.

5. The article of claim 1, wherein the polymeric resin attachment comprises glass fiber in an amount of 5 wt. % to 35 wt. % of the total weight of the polymeric resin attachment.

6. The article of claim 1, wherein the polymeric resin attachment comprises glass bead in an amount of 5 wt. % to 35 wt. % of the total weight of the polymeric resin attachment.

7. The article of claim 1, wherein the cap substrate comprises a glass, a wood, a metal, a fiber sheet, or a combination comprising at least one of the forgoing.

8. The article of claim 1, wherein the cap substrate comprises glass and the cap substrate has a thickness as measured along the shortest dimension of the cap substrate of 0.05 mm to 1 mm; or wherein the cap substrate comprises chemically strengthened glass and the cap substrate has a thickness as measured along the shortest dimension of 0.3 mm to 1 mm; or wherein the cap substrate comprises non-strengthened glass and the cap substrate has a thickness as measured along the shortest dimension of 0.05 mm to 0.3 mm; or wherein the cap substrate comprises optically transparent synthetic crystal and the cap substrate has a thickness as measured along the shortest dimension of 0.06 mm to 2 mm.

9. The article of claim 1, wherein the base substrate comprises polycarbonate, polyester, polypropylene, poly(methyl methacrylate), polycarbonate-dimethyl bisphenol cyclohexane, polyestercarbonate, polyetherimide, or a combination comprising at least one of the foregoing.

10. The article of claim 1, further comprising a functional layer, wherein the functional layer is disposed between the adhesive and the first surface of the base substrate; or wherein the functional layer is disposed between the adhesive and the second surface of the cap substrate.

11. The article of claim 1, wherein the polymeric resin attachment forms a border that surrounds the mold insert in at least one dimension.

12. The article of claim 1, wherein the adhesive comprises epoxy, acrylate, amine, urethane, silicone, thermal plastic urethane, ethyl vinyl acetate, HALS free EVA, or a combination comprising at least one of the foregoing.

13. A housing for an electronic device comprising the article of claim 1.

14. An electronic device comprising an electronic component and the article of claim 1, wherein the electronic component is housed inside the article.

15. The electronic device of claim 14, wherein the electronic device comprises a mobile phone, electronic tablet, e-reader, or a combination comprising at least one of the foregoing.

16. A shelf for an appliance, a face shield, or an automotive interface comprising the article of claim 1.

17. A method for forming an article of manufacturing comprising:
applying an adhesive to a surface of a first substrate;
coupling a second substrate to the adhesive to form a mold insert, wherein the adhesive is sandwiched between the first substrate and the second substrate;
molding a polymeric resin attachment to the mold insert in an injection molding process to form an article; wherein the polymeric resin attachment is coupled to a portion of one of the first substrate and second substrate, and wherein the polymeric resin attachment extends along a portion of an edge of the mold insert.

18. The method of claim 17, further comprising applying a functional layer to one of the first substrate and second substrate.

19. The method of claim 17, further comprising mixing a functional material with the adhesive.

20. The method of claim 17, further comprising printing an image onto a second surface of one of the first substrate or second substrate; wherein the image is disposed between the first substrate and the second substrate.
